(19) United States
(12) Patent Application Publication
(10) Pub. No.: US 2024/0147565 A1
(43) Pub. Date: May 2, 2024

(54) TCI STATE INDICATION METHOD AND APPARATUS, TERMINAL, AND NETWORK SIDE DEVICE

(71) Applicant: VIVO MOBILE COMMUNICATION CO., LTD., Guangdong (CN)

(72) Inventors: Rongrong SUN, Guangdong (CN); Yu YANG, Guangdong (CN); Yang SONG, Guangdong (CN); Peng SUN, Guangdong (CN)

(21) Appl. No.: 18/409,192

(22) Filed: Jan. 10, 2024

Related U.S. Application Data
(63) Continuation of application No. PCT/CN2022/105515, filed on Jul. 13, 2022.

(30) Foreign Application Priority Data
Jul. 16, 2021 (CN) 202110807949.2

(51) Int. Cl. H04W 76/20; H04W 72/231; H04W 80/02

(52) U.S. Cl. CPC H04W 76/20; H04W 72/231; H04W 80/02

(57) ABSTRACT

This application discloses a TCI state indication method and apparatus, a terminal, and a network side device, and pertains to the field of communications technologies. The TCI state indication method in embodiments of this application includes: receiving, by a terminal, RRC signaling, where the RRC signaling is used to indicate at least one of a resource pool of a TCI state and a mode of the TCI state; and receiving, by the terminal, a first MAC CE, where the first MAC CE is configured to activate at least one TCI state corresponding to the resource pool of the TCI state or the mode of the TCI state.

### CROSS-REFERENCE TO RELATED APPLICATIONS

The present application is a continuation application of International Application No. PCT/CN2022/105515 filed on Jul. 13, 2022, which claims priority of Chinese Patent Application No. 202110807949.2, filed with the China National Intellectual Property Administration on Jul. 16, 2021, and entitled “TCI STATE INDICATION METHOD AND APPARATUS, TERMINAL, AND NETWORK SIDE DEVICE”, both of which are incorporated herein by reference in their entireties.

### TECHNICAL FIELD

This application belongs to the field of communications technologies, and specifically relates to a transmission configuration indication (Transmission Configuration Indication, TCI) state (state) indication method and apparatus, a terminal, and a network side device.

### BACKGROUND

To improve beam management efficiency and reduce a beam update delay, a unified TCI framework is introduced in a mobile communications system, that is, a unified set of beam indication information is used for uplink and downlink transmission. However, in a unified TCI framework, how a terminal determines a TCI state used for transmission on a target resource is a technical problem that needs to be urgently resolved in a related technology.

### SUMMARY

Embodiments of this application provide a TCI state indication method and apparatus, a terminal, and a network side device, which can resolve a problem that a terminal cannot determine a TCI state used for transmission on a target resource and cannot transmit the target resource.

According to a first aspect, a TCI state indication method is provided, and includes: receiving, by a terminal, Radio Resource Control (Radio Resource Control, RRC) signaling, where the RRC signaling is used to indicate at least one of a resource pool of a TCI state and a mode of the TCI state; and receiving, by the terminal, a first Media Access Control control element (Media Access Control-Control Element, MAC CE), where the first MAC CE is configured to activate at least one TCI state corresponding to the resource pool of the TCI state or the mode of the TCI state.

According to a second aspect, a TCI state indication method is provided, and includes: sending, by a network side device, RRC signaling, where the RRC signaling is used to indicate at least one of a resource pool of a TCI state and a mode of the TCI state; and sending, by the network side device, a first MAC CE, where the first MAC CE is configured to activate at least one TCI state corresponding to the resource pool of the TCI state or the mode of the TCI state.

According to a third aspect, a TCI state indication apparatus is provided, and includes a receiving module, configured to: receive RRC signaling, where the RRC signaling is used to indicate at least one of a resource pool of a TCI state and a mode of the TCI state; and receiving a first MAC CE, where the first MAC CE is configured to activate at least one TCI state corresponding to the resource pool of the TCI state or the mode of the TCI state.

According to a fourth aspect, a TCI state indication apparatus is provided, and includes a sending module, configured to: send RRC signaling, where the RRC signaling is used to indicate at least one of a resource pool of a TCI state and a mode of the TCI state; and send a first MAC CE, where the first MAC CE is configured to activate at least one TCI state corresponding to the resource pool of the TCI state or the mode of the TCI state.

According to a fifth aspect, a terminal is provided. The terminal includes a processor, a memory, and a program or an instruction that is stored in the memory and that can be run on the processor, and the program or the instruction is executed by the processor to implement the method in the first aspect.

According to a sixth aspect, a terminal is provided, and includes a processor and a communications interface. The processor is configured to determine a target TCI state used for transmission on a target resource, and the communications interface is configured to: receive RRC signaling, where the RRC signaling is used to indicate at least one of a resource pool of a TCI state and a mode of the TCI state; and receive a first MAC CE, where the first MAC CE is configured to activate at least one TCI state corresponding to the resource pool of the TCI state or the mode of the TCI state.

According to a seventh aspect, a network side device is provided. The network side device includes a processor, a memory, and a program or an instruction that is stored in the memory and that can be run on the processor, and the program or the instruction is executed by the processor to implement the method in the second aspect.

According to an eighth aspect, a network side device is provided, and includes a processor and a communications interface. The communications interface is configured to: send RRC signaling, where the RRC signaling is used to indicate at least one of a resource pool of a TCI state and a mode of the TCI state; and send a first MAC CE, where the first MAC CE is configured to activate at least one TCI state corresponding to the resource pool of the TCI state or the mode of the TCI state.

According to a ninth aspect, a readable storage medium is provided. The readable storage medium stores a program or an instruction, and the program or the instruction is executed by a processor to implement the method in the first aspect or the method in the second aspect.

According to a tenth aspect, a chip is provided. The chip includes a processor and a communications interface, the communications interface is coupled to the processor, and the processor is configured to run a program or an instruction to implement the method in the first aspect or the method in the second aspect.

According to an eleventh aspect, a computer program/program product is provided. The program/program product is stored in a storage medium, and the program/program product is executed by at least one processor to implement the method in the first aspect or the method in the second aspect.

In the embodiments of this application, a terminal receives RRC signaling, where the RRC signaling is used to indicate at least one of a resource pool of a TCI state and a mode of the TCI state; and then the terminal receives a first MAC CE, where the first MAC CE is used to activate at least one TCI state corresponding to the resource pool of the TCI state or the mode of the TCI state. In the embodiments of this application, it is convenient for the terminal to determine a target TCI state used for transmission on a target resource, and the terminal can further transmit the target resource based on the determined target TCI state, thereby improving communication validity.

### BRIEF DESCRIPTION OF DRAWINGS

FIG. 1 is a schematic diagram of a wireless communications system according to an embodiment of this application;

FIG. 2 is a schematic flowchart of a TCI state indication method according to an embodiment of this application;

FIG. 3 is a schematic flowchart of a TCI state indication method according to an embodiment of this application;

FIG. 4 is a schematic diagram of a structure of a TCI state indication apparatus according to an embodiment of this application;

FIG. 5 is a schematic diagram of a structure of a TCI state indication apparatus according to an embodiment of this application;

FIG. 6 is a schematic diagram of a structure of a communications device according to an embodiment of this application;

FIG. 7 is a schematic diagram of a structure of a terminal according to an embodiment of this application; and

FIG. 8 is a schematic diagram of a structure of a network side device according to an embodiment of this application.

### DESCRIPTION OF EMBODIMENTS

The following clearly describes technical solutions in embodiments of this application with reference to accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “I” generally represents an “or” relationship between associated objects.

It should be noted that, the technologies described in the embodiments of this application are not limited to a Long Term Evolution (Long Term Evolution, LTE)/LTE-Advanced (LTE-Advanced, LTE-A) system, and can also be used in other wireless communication systems such as Code Division Multiple Access (Code Division Multiple Access, CDMA), Time Division Multiple Access (Time Division Multiple Access, TDMA), Frequency Division Multiple Access (Frequency Division Multiple Access, FDMA), Orthogonal Frequency Division Multiple Access (Orthogonal Frequency Division Multiple Access, OFDMA), Single-carrier Frequency-Division Multiple Access (Single-carrier Frequency-Division Multiple Access, SC-FDMA), and another system. The terms “system” and “network” in the embodiments of this application may be used interchangeably. The technologies described can be applied to both the systems and the radio technologies mentioned above as well as to other systems and radio technologies. A new radio (New Radio, NR) system is described below for an illustration purpose, and the term NR is used in most of the descriptions, although these technologies can also be used in an application other than an NR system application, for example, a 6^{th} generation (6^{th} Generation, 6G) communications system.

FIG. 1 is a schematic diagram of a wireless communications system to which embodiments of this application can be applied. The wireless communications system includes a terminal 11 and a network side device 12. The terminal 11 may also be referred to as a terminal device or user equipment (User Equipment, UE). The terminal 11 may be a terminal side device such as a mobile phone, a tablet personal computer (Tablet Personal Computer), a laptop computer (Laptop Computer) or a notebook computer, a personal digital assistant (Personal Digital Assistant, PDA), a palmtop computer, a netbook, an ultra-mobile personal computer (ultra-mobile personal computer, UMPC), a mobile Internet device (Mobile Internet Device, MID), a wearable device (Wearable Device), vehicle user equipment (VUE), or pedestrian user equipment (PUE). The wearable device includes a smart watch, a bracelet, a headset, glasses, and the like. It should be noted that a specific type of the terminal 11 is not limited in the embodiments of this application. The network side device 12 may be a base station or a core network device, and the base station may be referred to as a NodeB, an evolved NodeB, an access point, a base transceiver station (Base Transceiver Station, BTS), a radio base station, a radio transceiver, a basic service set (Basic Service Set, BSS), an extended service set (Extended Service Set, ESS), a NodeB, an evolved NodeB (eNB), a home NodeB, a home evolved NodeB, a WLAN access point, a WiFi node, a transmitting receiving point (Transmitting Receiving Point, TRP), or another appropriate term in the art. Provided that the same technical effect is achieved, the base station is not limited to specific technical vocabulary. It should be noted that a base station in an NR system is merely used as an example, but a specific type of the base station is not limited in the embodiments of this application.

A transmission configuration indication (Transmission Configuration Indication, TCI) state indication method and apparatus, a terminal, and a network side device that are provided in the embodiments of this application are described in detail below with reference to the accompanying drawings by using some embodiments and application scenarios.

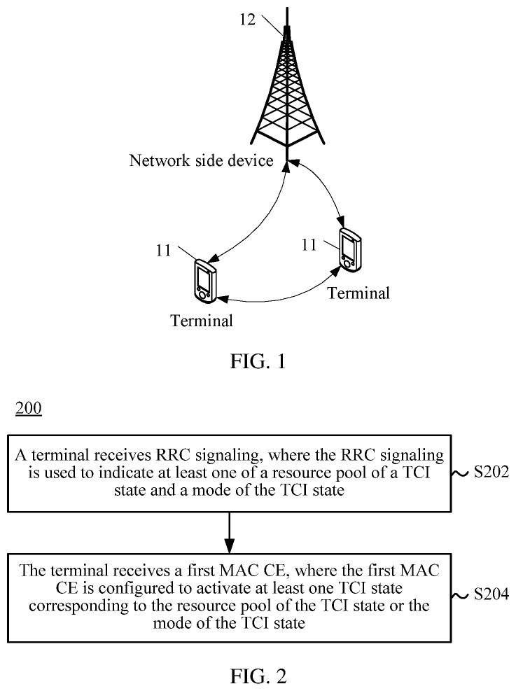

As shown in FIG. 2, an embodiment of this application provides a TCI state indication method 200. The method may be performed by a terminal. In other words, the method may be performed by software or hardware installed in the terminal. The method includes the following steps.

S202: The terminal receives Radio Resource Control (Radio Resource Control, RRC) signaling, where the RRC signaling is used to indicate at least one of a resource pool of a TCI state and a mode of the TCI state.

The resource pool of the TCI state may include a plurality of TCI states, and may further include a plurality of types of TCI states, for example, a joint (joint) TCI state and a separate (separate) TCI state.

The joint TCI state mentioned in the embodiments of this application may be that the terminal uses a unified set of beam indication information for uplink and downlink transmission, that is, a unified joint TCI state is used, and one joint TCI state may be applied to one or more channels or signals. For the separate TCI state mentioned in the embodiments of this application, each group of separate TCI states may include an uplink TCI state and a downlink TCI state, one downlink TCI state is applied to one or more downlink channels or signals, and one uplink TCI state is applied to one or more uplink channels or signals.

The mode of the TCI state may include a joint indication or a separate indication.

The joint indication mentioned in the embodiments of this application may be that the terminal uses a unified set of beam indication information (for example, a unified joint TCI state) for uplink and downlink transmission. The separate indication mentioned in the embodiments of this application may be that the terminal indicates a group of separate TCI states, a downlink TCI state of the separate TCI state is applied to a downlink channel or signal, and an uplink TCI state of the separate TCI state is applied to an uplink channel or signal.

In a multi-TRP scenario, the terminal or a target resource may be indicated by a plurality of joint TCI states, each joint TCI state corresponds to one TRP, and the terminal or the target resource may be indicated by a plurality of groups of separate TCI states, and each group of separate TCI states corresponds to one TRP.

S204: The terminal receives a first Media Access Control control element (Media Access Control-Control Element, MAC CE), where the first MAC CE is configured to activate at least one TCI state corresponding to the resource pool of the TCI state or the mode of the TCI state.

Optionally, the first MAC CE includes at least one of the following: a control resource set resource pool index (CORESETPoolIndex), a sounding reference signal (Sounding Reference Signal, SRS) resource set identifier, an antenna panel identifier, a resource pool identifier of a TCI state, the mode of the TCI state, and at least one piece of code point information. For example, in this embodiment, the first MAC CE includes a TRP identifier, and the TRP identifier is associated with at least one of the following: a CORESETPoolIndex, an SRS resource set identifier, a panel identifier, a resource pool identifier of the TCI state, and the mode of the TCI state. In addition, the first MAC CE includes at least one piece of code point information.

Optionally, after S204, the terminal may further determine a target TCI state used for transmission on a target resource.

The target resource mentioned in the embodiments of this application may include at least one of the following: a physical downlink control channel (Physical Downlink Control Channel, PDCCH), a control resource set (Control Resource SET, CORESET), search space (Search Space, SS), a physical downlink shared channel (Physical Downlink Shared Channel, PDSCH), a physical uplink control channel (Physical Uplink Control Channel, PUCCH), a physical uplink shared channel (Physical Uplink Shared Channel, PUSCH), a channel state information-reference signal (Channel State Information-Reference Signal, CSI-RS), a sounding reference signal (Sounding Reference Signal, SRS) resource, or an SRS resource set.

In an example, the terminal may use a preset TCI state in TCI states activated by the first MAC CE as the target TCI state, and the preset TCI state may be at least one of the following:
(1) a TCI state corresponding to a minimum code point in the first MAC CE;
(2) a plurality of TCI states corresponding to a minimum code point including a plurality of TCI states in the first MAC CE;
(3) a TCI state corresponding to a minimum code point including one TCI state in the first MAC CE; and
(4) a TCI state corresponding to a minimum code point including only one downlink/uplink TCI state in the first MAC CE.

In another example, the terminal uses a TCI state associated with a preset code point in the first MAC CE as the target TCI state. For the preset code point, refer to the minimum code point described in the foregoing (1) to (4).

In still another example, after S204, the terminal may further receive a second MAC CE or first downlink control information (Downlink Control Information, DCI), where the second MAC CE or the first DCI is used to indicate a target TCI state used for transmission on the target resource, and the target TCI state is at least one of TCI states activated by the first MAC CE. In this way, the terminal may subsequently determine, based on an indication of the second MAC CE or the first DCI, the target TCI state used for transmission on the target resource. For ease of description, subsequently, the second MAC CE and the first DCI may be collectively referred to as a first command.

In this example, the second MAC CE or the first DCI received by the terminal may be used to indicate the TCI state, and the TCI state indicated by the second MAC CE or the first DCI may include at least one of the following: one or more joint TCI states, and one or more groups of separate TCI states. Each group of separate TCI states may include an uplink TCI state and a downlink TCI state.

Optionally, the second MAC CE or the first DCI may be used to indicate one or more TCI states, and each TCI state may be applied to a plurality of channels or signals.

In an example, the second MAC CE or the first DCI indicates one or more joint TCI states, and this step may include: in a case that the second MAC CE or the first DCI indicates one joint TCI state, use the joint TCI state as the TCI state used by the target resource; and in a case that the second MAC CE or the first DCI indicates a plurality of joint TCI states, use a first target joint TCI state in the plurality of joint TCI states as the TCI state used by the target resource. In this example, the first target joint TCI state may be the first joint TCI state, the last joint TCI state, or the like in the plurality of joint TCI states indicated by the second MAC CE or the first DCI.

In another example, the second MAC CE or the first DCI indicates a plurality of downlink TCI states and/or a plurality of uplink TCI states, and this step may include: in a case that the target resource is a downlink resource, use a first target downlink TCI state in the plurality of downlink TCI states as the TCI state used by the target resource; and in a case that the target resource is an uplink resource, use a first target downlink TCI state in the plurality of uplink TCI states as the TCI state used by the target resource. In this example, the first target downlink TCI state may be the first downlink TCI state, the last downlink TCI state, or the like in the plurality of downlink TCI states indicated by the second MAC CE or the first DCI. The first target uplink TCI state may be the first uplink TCI state, the last uplink TCI state, or the like in the plurality of uplink TCI states indicated by the second MAC CE or the first DCI.

The TCI state indication method provided in the embodiments of this application may be applied to a unified TCI framework, and can flexibly indicate the TCI state used by the target resource. The unified TCI framework is that the terminal uses a unified set of beam indication information for uplink and downlink transmission. For example, one beam is used in both uplink and downlink. When a network side device indicates a TCI state to the terminal by using the second MAC CE or the first DCI, a plurality of uplink and downlink channels or signals may use the TCI state (referred to as a joint TCI state). In another solution, the network side device indicates a pair of beams to the terminal by using the second MAC CE or the first DCI, that is, two TCI states (that is, a group of separate TCI states). One downlink TCI state is applied to a downlink channel or signal, and the other uplink TCI state is applied to an uplink channel or signal. The two TCI states may be referred to as separate TCI states.

According to the TCI state indication method provided in this embodiment of this application, a terminal receives RRC signaling, where the RRC signaling is used to indicate at least one of a resource pool of a TCI state and a mode of the TCI state; and then the terminal receives a first MAC CE, where the first MAC CE is used to activate at least one TCI state corresponding to the resource pool of the TCI state or the mode of the TCI state. In this embodiment of this application, it is convenient for the terminal to determine a target TCI state used for transmission on a target resource, and the terminal can further transmit the target resource based on the determined target TCI state, thereby improving communication validity.

Optionally, the resource pool of the TCI state in the foregoing embodiments meets at least one of the following:
(1) The resource pool of the TCI state is associated with a control resource set resource pool index (CORESETPoolIndex). Because the CORESETPoolIndex is associated with a TRP, the resource pool of the TCI state is also associated with the TRP.
(2) The resource pool of the TCI state is associated with the target TCI state. In other words, the target TCI state determined by the terminal may be a TCI state in the foregoing resource pool.
(3) The resource pool of the TCI state is associated with a format of second DCI, and the second DCI is used to schedule the target resource. The second DCI in this embodiment and the foregoing first DCI used to indicate the TCI state may be same DCI, or may be different DCI.
(4) The resource pool of the TCI state is associated with the mode of the TCI state. The terminal can determine the mode of the TCI state based on the resource pool of the TCI state.
(5) The resource pool of the TCI state is associated with the target resource. The terminal can select a TCI state in the resource pool of the TCI state based on the target resource.

Optionally, the mode of the TCI state in the foregoing embodiments meets at least one of the following:
(1) The mode of the TCI state is associated with a CORESETPoolIndex. Because the CORESETPoolIndex is associated with a TRP, the mode of the TCI state is also associated with the TRP.
(2) The mode of the TCI state is associated with the target TCI state. In other words, the terminal may determine a mode of the target TCI state corresponding to the target resource.
(3) The mode of the TCI state is associated with a format of second DCI, and the second DCI is used to schedule the target resource. The terminal may determine the mode of the TCI state based on the format of the second DCI. The second DCI in this embodiment and the foregoing first DCI used to indicate the TCI state may be same DCI, or may be different DCI.
(4) The resource pool of the TCI state is associated with the mode of the TCI state. The terminal can determine the mode of the TCI state based on the resource pool of the TCI state.
(5) The mode of the TCI state is associated with the target resource. The terminal can determine, based on the target resource, a mode of the TCI state used to transmit the target resource.

For example, in the foregoing two embodiments, a TCI state that a code point corresponding to the first MAC CE is first associated with corresponds to a TRP 1, that is, corresponds to a first-configured resource pool of the TCI state and a first-configured mode of the TCI state; and a TCI state that a code point corresponding to the first MAC CE is later associated with corresponds to a TRP 2, that is, corresponds to a later-configured resource pool of the TCI state and a later-configured mode of the TCI state.

In the foregoing two embodiments, the network side device may configure whether the mode of the TCI state is separate or joint. These modes may be associated with the TRP, and the TRP may be distinguished by using a resource pool identifier of the TCI state.

Based on an association relationship described in the foregoing two embodiments, in a multi-TRP/multi-panel (multi-TRP/multi-panel, M-TRP/TRP) scenario, different modes of the TCI state may be configured for different TRPs based on a capability of the terminal and a channel condition, thereby increasing network configuration flexibility and ensuring uplink transmission performance.

Optionally, in a multi-TRP scenario, for example, in a case that there are two TRPs, the foregoing mode of the TCI state specifically includes at least one of the following: (1) The two TRPs have same corresponding, and both are joint indication. (2) The two TRPs have same corresponding, and both are separate indication. (3) The two TRPs have different corresponding, the first one is joint indication, and the second one is separate indication. (4) The two TRPs have different corresponding, the first one is separate indication, and the second one is joint indication.

It should be noted that the TRP mentioned in the embodiments of this application may be explicitly identified by a TRP identifier (ID), or may be identified by a panel identifier (Panel ID); or may be implicitly identified by a reference signal, a reference signal resource set identifier, or the like.

Optionally, the first MAC CE includes (N pieces of, N is a positive integer) code point information, the code point information is used to indicate a to-be-activated TCI state, and (each piece of) the code point information includes at least one of the following:
(1) an identifier of the activated TCI state selected from the resource pool of the TCI state;
(2) an identifier used to distinguish between uplink and downlink;
(3) an identifier used to distinguish a TCI state group to which the activated TCI state belongs, where generally, one TCI state group corresponds to one TRP; and
(4) a mode of the activated TCI state, where the mode of the activated TCI state includes joint indication or separate indication, for example, 2 bits indicate the joint indication or downlink or uplink of the separate indication.

Optionally, the first DCI includes a TCI field, and the TCI field is mapped to a code point in the first MAC CE, so that the terminal obtains the target TCI state used for transmission on the target resource.

In an example, the first DCI includes one TCI field, the TCI field corresponds to target code point information in the first MAC CE, and the target code point information is one piece of code point information included in the first MAC CE.

In an example, the first DCI includes one TCI field, and the TCI field corresponds to a plurality of (for example, two) pieces of target code point information in the first MACCE. For example, modes of TCI states activated by two first MAC CEs are different. For example, one is joint indication, and the other is separate indication. The two first MAC CEs may correspond to two TRPs.

In an example, the first DCI includes a plurality of TCI fields, and the plurality of TCI fields correspond to different target code point information in one first MAC CE.

In an example, the first DCI includes a plurality of TCI fields, and each TCI field corresponds to one first MAC CE. In other words, the plurality of TCI fields and a plurality of first MAC CEs may be in a one-to-one correspondence, and each TCI field in the plurality of TCI fields corresponds to one piece of target code point information in the first MAC CE. For example, the first DCI includes two TCI fields, and each value is separately mapped to one piece of code point information in one first MAC CE.

Optionally, based on Embodiment 200, the second MAC CE or the first DCI may include a first indication field, and the first indication field is used by the terminal to determine at least one of the following based on a plurality of currently effective TCI states:
(1) A quantity of TCI states associated with the target resource. In this embodiment, by setting the foregoing first indication field, it is convenient to implement flexible single-TRP and multiple-TRP switching, thereby improving flexibility of transmission of the target resource. For example, the second MAC CE or the first DCI indicates that one TCI state is used to transmit the target resource, that is, single-TRP transmission of the target resource is implemented. For another example, the second MAC CE or the first DCI indicates that a plurality of TCI states are used by the target resource, that is, multi-TRP transmission of the target resource is implemented.

(2) An identifier of a TCI state associated with the target resource.

(3) A sequence of a plurality of TCI states associated with the target resource, for example, an order.

The plurality of currently effective TCI states mentioned in this embodiment are indicated by the second MAC CE or the first DCI.

In an example, the first indication field included in the second MAC CE or the first DCI may be 1 bit. 0 indicates that the first TCI state in a plurality of TCI states indicated for the target resource is used to transmit the target resource, and 1 indicates that a plurality of TCI states are used simultaneously.

In an example, the first indication field included in the second MAC CE or the first DCI may be 2 bits. 00 indicates that the first TCI state in a plurality of TCI states indicated for the target resource is used to transmit the target resource; 01 indicates that the second TCI state in the plurality of TCI states indicated for the target resource is used to transmit the target resource; 10 indicates that the first TCI state and the second TCI state indicated for the target resource are used to transmit the target resource; and 11 indicates that the second TCI state and the first TCI state indicated for the target resource are used to transmit the target resource.

Optionally, based on Embodiment 200, the method further includes: receiving, by the terminal, second DCI, where the second DCI is used to schedule the target resource, the second DCI includes a first indication field, and the first indication field is used by the terminal to determine at least one of the following based on a plurality of currently effective TCI states: a quantity of TCI states associated with the target resource, an identifier of a TCI state associated with the target resource, and a sequence of a plurality of TCI states associated with the target resource. The plurality of currently effective TCI states are indicated by the second MAC CE or the first DCI.

Optionally, based on Embodiment 200, the target resource is scheduled by using the second DCI, and the terminal may further determine, based on a format of the second DCI, the target TCI state used for transmission on the target resource. In an example, the format of the second DCI includes one of the following: DCI format 1_0 and DCI format 0_0.

For example, in this embodiment, for a target resource scheduled in a specific DCI format, only one preset TCI state in a plurality of TCI states indicated by the second MAC CE or the first DCI is used, and the specific DCI format may be a DCI format (format) 1_0 or a DCI format 0_0. The preset TCI state may be the first TCI state in the plurality of TCI states indicated by the second MAC CE or the first DCI, or a TCI state with a minimum identifier.

Optionally, based on Embodiment 200, the second MAC CE or the first DCI is associated with a CORESETPoolIndex, and the method further includes: determining, by the terminal based on at least one of the following, a target TCI state used by the target resource: the second MAC CE or the first DCI, or the CORESETPoolIndex.

In this embodiment, that the second MAC CE or the first DCI is associated with the CORESETPoolIndex includes: the second MAC CE includes an indication field indicating the CORESETPoolIndex; or a first CORESET in which the first DCI is located is associated with the CORESETPoolIndex.

In this embodiment, the foregoing association relationship may be indirectly determined by using CORESET. For example, if a first CORESET is associated with the CORESETPoolIndex, first DCI from the first CORESET is associated with the CORESETPoolIndex.

This embodiment may be applied to a multi-TRP transmission scenario of multiple DCI (Multiple-Downlink Control Information, M-DCI), so that the terminal determines the TCI state used by the target resource.

Optionally, based on Embodiment 200, the target resource is associated with a CORESETPoolIndex, and the method further includes: determining, based on at least one of the following, a target TCI state used by the target resource: the second MACCE or the first DCI, or the CORESETPoolIndex.

In an example, the TCI state used by the target resource and associated with the CORESETPoolIndex is indicated by the second MAC CE or the first DCI associated with the CORESETPoolIndex.

In an example, the TCI state used by the target resource and associated with the CORESETPoolIndex is indicated by the second MAC CE, and the second MAC CE meets at least one of the following:
(1) The second MAC CE is with the CORESETPoolIndex. This indication method may be an explicit indication, for example, the second MAC CE is associated with the CORESETPoolIndex.
(2) The target TCI state used by the target resource is determined in an arrangement sequence of a plurality of TCI states in the second MAC CE.

The indication method may be an implicit indication, and the target TCI state used by the target resource may be determined based on an arrangement sequence of the TCI state in the second MAC CE. For example, the first TCI state in the second MAC CE corresponds to CORESETPooLIndex0, and the second TCI state in the second MAC CE corresponds to CORESETPooLIndex 1. In this example, CORESETPooLIndex0 and/or CORESETPooLIndex 1 are/is associated with the target resource.
(3) The target TCI state used by the target resource is a TCI state corresponding to a preset code point in the second MAC CE. For example, a TCI state corresponding to the preset code point in the second MAC CE is the target TCI state used for transmission on the target resource.

Optionally, that the target resource is associated with the CORESETPoolIndex meets one of the following:
(1) A second CORESET in which the second DCI is located is associated with the CORESETPoolIndex, and the second DCI is used to schedule the target resource.

In this example, for example, if the second DCI for scheduling the target resource is located in a CORESET associated with a specific CORESETPoolIndex, the target resource is associated with the CORESETPoolIndex.
(2) CORESETPoolIndex associated with configuration of the target resource is configured by using higher layer signaling.

This example may be explicitly configured by RRC. For example, a network side device configures at least one of the following for the terminal by using the RRC: an SRS resource or a resource set (that is, the target resource) is associated with a CORESETPoolIndex parameter; a PUCCH resource (that is, the target resource) is associated with the CORESETPoolIndex; a CSI-RS resource (that is, the target resource) is associated with the CORESETPoolIndex.
(3) There is a mapping relationship between an identifier of the target resource and an identifier of the CORESETPoolIndex. For example, in a plurality of target resources, a target resource with a small identifier corresponds to CORESETPoolIndex 0, and a resource with a large identifier corresponds to CORESETPoolIndex 1.

Optionally, based on Embodiment 200, the second MAC CE or the first DCI includes a second indication field, and the second indication field is used to indicate that a target TCI state in the second MAC CE or the first DCI is applied to the target resource associated with a target CORESETPoolIndex. For example, the first DCI includes a target field of 1 bit, and 0 indicates that the TCI state is applied to a target resource associated with a CORESETPoolIndex0.

The solution in which the target resource is associated with the CORESETPoolIndex that is described in the foregoing embodiments may be applied to a multi-TRP transmission scenarios of a plurality of DCI (M-DCI), and helps the terminal determine the TCI state used by the target resource.

Optionally, based on Embodiment 200, the second MAC CE or the first DCI indicates a plurality of TCI states. Embodiment 200 further includes at least one of the following:
(1) In a case that the target resource is a PDCCH, a TCI state used to transmit the PDCCH is determined, based on an identifier of search space associated with the PDCCH, from the plurality of TCI states indicated by the second MAC CE or the first DCI.
(2) In a case that the target resource is a PDCCH, a TCI state used to transmit the PDCCH is determined, based on an identifier of a control resource set associated with search space associated with the PDCCH, from the plurality of TCI states indicated by the second MAC CE or the first DCI.

Optionally, the plurality of TCI states indicated by the second MAC CE or the first DCI include a first TCI state and a second TCI state, the search space includes first search space and second search space, and the determining a TCI state used to transmit the PDCCH from the plurality of TCI states mentioned in the foregoing (1) includes: A PDCCH transmitted by using the first search space uses the first TCI state, and a PDCCH transmitted by using the second search space uses the second TCI state.

Optionally, the plurality of TCI states include a first TCI state and a second TCI state, the control resource set includes a first control resource set and a second control resource set, and the determining a TCI state used to transmit the PDCCH from the plurality of TCI states mentioned in the foregoing (2): A PDCCH transmitted by using the first control resource set uses the first TCI state, and a PDCCH transmitted by using the second control resource set uses the second TCI state.

For example, in this embodiment, when the second MAC CE or the first DCI indicates two joint (joint) TCI states, when the target resource is a PDCCH, in associated search space, search space with a small identifier uses a first joint TCI state, and search space with a large identifier uses a second joint TCI state; or search space with a small identifier of CORESET associated with the search space uses a first joint TCI state, and search space with a large identifier of the CORESET uses a second joint TCI state.

In this embodiment, ab association relationship between the search space and the PDCCH may be indicated by RRC signaling.

For another example, in this embodiment, when the second MAC CE or the first DCI indicates two downlink (DownLink, DL) TCI states and two uplink (UpLink, UL) TCI states, when the target resource is a PDCCH, in associated search space, search space with a small identifier uses a first downlink TCI state, and search space with a large identifier uses a second TCI state; or search space with a small identifier of CORESET associated with the search space uses a first downlink TCI state, and search space with a large identifier of the CORESET uses a second downlink TCI state.

Optionally, based on Embodiment 200, the second MAC CE or the first DCI indicates a plurality of TCI states, and the method further includes at least one of the following:
(1) in a case that the target resource is a PUSCH and an SRS resource set used for transmission on the PUSCH is associated with a CSI-RS, determining, from the plurality of TCI states based on an identifier of the SRS resource set, a TCI state used for transmission on the CSI-RS; and
(2) in a case that the target resource is a PUSCH, determining, from the plurality of TCI states based on an identifier of an SRS resource set, a TCI state used for transmission on the SRS resource set, where the SRS resource set is used for transmission on the PUSCH.

Optionally, the plurality of TCI states include a first TCI state and a second TCI state, the SRS resource set includes a first SRS resource set and a second SRS resource set, and the determining, from the plurality of TCI states based on an identifier of the SRS resource set, a TCI state used for transmission on the CSI-RS in the foregoing (1) includes: A CSI-RS associated with the first SRS resource set uses the first TCI state, and a CSI-RS associated with the second SRS resource set uses the second TCI state.

Optionally, the plurality of TCI states include a first TCI state and a second TCI state, the SRS resource set includes a first SRS resource set and a second SRS resource set, and the determining, from the plurality of TCI states based on an identifier of the SRS resource set, a TCI state used for transmission on the SRS resource set in the foregoing (2) includes: The first SRS resource set uses the first TCI state, and the second SRS resource set uses the second TCI state.

For example, in this embodiment, when the second MAC CE or the first DCI indicates two joint (joint) TCI states, in a case that the target resource is a PUSCH and an SRS resource set used for transmission on the PUSCH is associated with a CSI-RS, CSI-RSs associated with a plurality of SRS resource sets separately use a plurality of TCI states, a CSI-RS associated with an SRS resource set with a small SRS resource set identifier uses a first joint TCI state, and a CSI-RS associated with an SRS resource set with a large SRS resource set identifier uses a second joint TCI state.

For example, in this embodiment, when the second MAC CE or the first DCI indicates two joint (joint) TCI states, in a case that the target resource is a PUSCH and a plurality of SRS resource sets used for transmission on the PUSCH separately use a plurality of TCI states, an SRS resource in an SRS resource set with a small SRS resource set identifier uses a first joint TCI state, and an SRS resource in an SRS resource set with a large SRS resource set identifier uses a second joint TCI state.

For another example, in this embodiment, when the second MAC CE or the first DCI indicates two downlink (DL) TCI states and two uplink (UL) TCI states, in a case that the target resource is a PUSCH and an SRS resource set used for transmission on the PUSCH is associated with a CSI-RS, CSI-RSs associated with a plurality of SRS resource sets separately use a plurality of downlink TCI states, a CSI-RS associated with an SRS resource set with a small SRS resource set identifier uses a first downlink TCI state, and a CSI-RS associated with an SRS resource set with a large SRS resource set identifier uses a second downlink TCI state. For another example, in this embodiment, when the second MAC CE or the first DCI indicates two downlink (DL) TCI states and two uplink (UL) TCI states, in a case that the target resource is a PUSCH and a plurality of SRS resource sets used for transmission on the PUSCH separately use a plurality of TCI states, an SRS resource in an SRS resource set with a small SRS resource set identifier uses a first uplink TCI state, and an SRS resource in an SRS resource set with a large SRS resource set identifier uses a second uplink TCI state.

It should be noted that the first TCI state and the second TCI state mentioned in the foregoing embodiments may be respectively the first TCI state and the second TCI state in code point information, or may be the first TCI state and the second TCI state that are sorted in a descending order (or an ascending order) of identifier sizes of the TCI states.

Similarly, the first joint TCI state and the second joint TCI state, the first uplink TCI state and the second uplink TCI state, and the first downlink TCI state and the second downlink TCI state mentioned in the foregoing embodiments may be distinguished based on a sequence in code point information, or may be distinguished based on identifier sizes of the TCI states.

The foregoing solution used by the terminal to determine the TCI state used for transmission on the target resource described in the foregoing embodiments may be applied to a multi-TRP transmission scenario, and helps the terminal determine the TCI state used for transmission on the target resource.

To describe in detail the TCI state indication method provided in the foregoing embodiments of this application, the following provides description with reference to a specific embodiment.

### Embodiment 1

In this embodiment, the network side device configures CORESETs associated with different values of CORESETPoolIndex for the terminal, and also configures two SRS resource sets (corresponding to the target resource in the foregoing embodiment) used for transmission on a codebook for the terminal. An SRS resource set with a small SRS resource set identifier is associated with a CORESETPoolIndex 0, and an SRS resource set with a large SRS resource set identifier is associated with a CORESETPoolIndex 1.

A TCI state indicated by DCI (corresponding to the first DCI in the foregoing embodiment) from the CORESET associated with the CORESETPoolIndex 0 is applied to an SRS resource in an SRS resource set associated with the CORESETPoolIndex 0.

A TCI state indicated by DCI (corresponding to the first DCI in the foregoing embodiment) from the CORESET associated with the CORESETPoolIndex 1 is applied to an SRS resource in an SRS resource set associated with the CORESETPoolIndex 1.

The TCI state indicated by the DCI (corresponding to the first DCI in the foregoing embodiment) from the CORESET associated with the CORESETPoolIndex 0 is applied to a PUSCH scheduled by the DCI from the CORESET of the CORESETPoolIndex 0.

The TCI state indicated by the DCI (corresponding to the first DCI in the foregoing embodiment) from the CORESET associated with the CORESETPoolIndex 1 is applied to a PUSCH scheduled by the DCI from the CORESET of the CORESETPoolIndex 1.

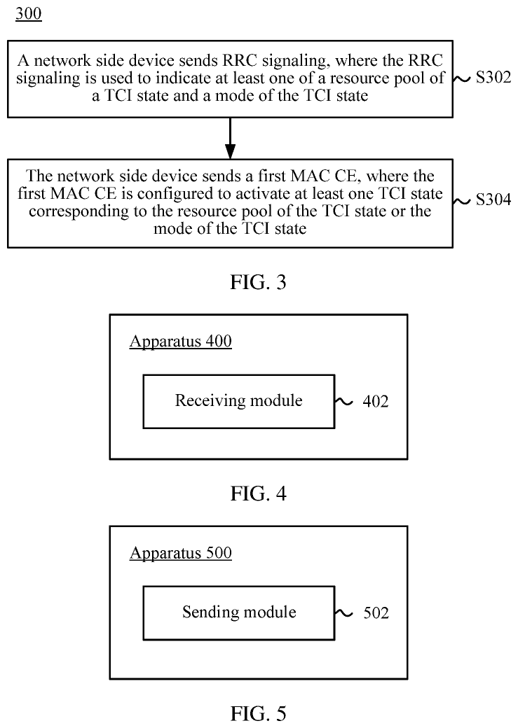

The TCI state indication method according to an embodiment of this application is described in detail above with reference to FIG. 2. A TCI state indication method according to another embodiment of this application is to be described in detail below with reference to FIG. 3. It can be understood that interaction between a network side device and a terminal described from the perspective of the network side device is the same as that described on the terminal side in the method shown in FIG. 2. To avoid repetition, related descriptions are appropriately omitted.

FIG. 3 is a schematic flowchart of implementing a TCI state indication method according to an embodiment of this application. The method may be applied to a network side device. As shown in FIG. 3, a method 300 includes the following steps.

S302: The network side device sends RRC signaling, where the RRC signaling is used to indicate at least one of a resource pool of a TCI state and a mode of the TCI state.

S304: The network side device sends a first MAC CE, where the first MAC CE is configured to activate at least one TCI state corresponding to the resource pool of the TCI state or the mode of the TCI state.

In this embodiment of this application, the network side device sends the RRC signaling, where the RRC signaling is used to indicate at least one of the resource pool of the TCI state and the mode of the TCI state; and then the network side device sends the first MAC CE, where the first MAC CE is used to activate at least one TCI state corresponding to the resource pool of the TCI state or the mode of the TCI state. In this embodiment of this application, it is convenient for a terminal to determine a target TCI state used for transmission on a target resource, and the terminal can further transmit the target resource based on the determined target TCI state, thereby improving communication validity.

Optionally, in an embodiment, after the network side device sends the first MAC CE, the method further includes: sending, by the network side device, a second MAC CE or first DCI, where the second MAC CE or the first DCI is used to indicate a target TCI state used for transmission on a target resource, and the target TCI state is at least one of TCI states activated by the first MAC CE.

Optionally, in an embodiment, the resource pool of the TCI state meets at least one of the following: the resource pool of the TCI state is associated with a CORESETPoolIndex; the resource pool of the TCI state is associated with the target TCI state; the resource pool of the TCI state is associated with a format of second DCI, and the second DCI is used to schedule the target resource; and the resource pool of the TCI state is associated with the mode of the TCI state.

Optionally, in an embodiment, the mode of the TCI state meets at least one of the following: the mode of the TCI state is associated with a CORESETPoolIndex; the mode of the TCI state is associated with the target TCI state; the mode of the TCI state is associated with a format of second DCI, and the second DCI is used to schedule the target resource; and the mode of the TCI state is associated with the resource pool of the TCI state.

Optionally, in an embodiment, the first MAC CE includes code point information, the code point information is used to indicate a to-be-activated TCI state, and the code point information includes at least one of the following: an identifier of the activated TCI state selected from the resource pool of the TCI state; an identifier used to distinguish between uplink and downlink; an identifier used to distinguish a TCI state group to which the activated TCI state belongs; and a mode of the activated TCI state, where the mode of the activated TCI state includes joint indication or separate indication.

Optionally, in an embodiment, the first DCI includes one TCI field, and the one TCI field corresponds to target code point information in one first MAC CE; the first DCI includes one TCI field, and the one TCI field corresponds to target code point information in a plurality of first MAC CEs; the first DCI includes a plurality of TCI fields, and the plurality of TCI fields correspond to different target code point information in one first MAC CE; or the first DCI includes a plurality of TCI fields, and each of the plurality of TCI fields corresponds to target code point information in one first MAC CE.

Optionally, in an embodiment, the first DCI includes a first indication field, the first indication field is used to indicate an association relationship between a plurality of currently effective TCI states and the target resource, and the association relationship includes at least one of the following: a quantity of TCI states associated with the target resource; an identifier of a TCI state associated with the target resource; and a sequence of a plurality of TCI states associated with the target resource.

Optionally, in an embodiment, the method further includes: sending, by the network side device, second DCI, where the second DCI is used to schedule the target resource. The target TCI state used for transmission on the target resource is determined by the terminal based on a format of the second DCI, and the format of the second DCI includes one of the following: DCI format 1_0 and DCI format 0_0.

Optionally, in an embodiment, the second MAC CE or the first DCI is associated with a CORESETPoolIndex.

Optionally, in an embodiment, the target resource is associated with a CORESETPoolIndex.

It should be noted that the TCI state indication method provided in the embodiments of this application may be performed by a TCI state indication apparatus, or a control module that is in the TCI state indication apparatus and that is configured to perform the TCI state indication method. In this embodiment of this application, an example in which the TCI state indication apparatus performs the TCI state indication method is used to describe the TCI state indication apparatus provided in the embodiments of this application.

FIG. 4 is a schematic diagram of a structure of a TCI state indication apparatus according to an embodiment of this application. The apparatus may correspond to a terminal in another embodiment. As shown in FIG. 4, an apparatus 400 includes the following modules:

A receiving module 402 may be configured to: receive RRC signaling, where the RRC signaling is used to indicate at least one of a resource pool of a TCI state and a mode of the TCI state; and receive a first MAC CE, where the first MAC CE is configured to activate at least one TCI state corresponding to the resource pool of the TCI state or the mode of the TCI state.

Optionally, the apparatus 400 further includes a processing module, configured to determine a target TCI state used by a target resource.

In this embodiment of this application, the apparatus 400 receives the RRC signaling, where the RRC signaling is used to indicate at least one of the resource pool of the TCI state and the mode of the TCI state; and then, the apparatus 400 receives the first MAC CE, where the first MAC CE is used to activate at least one TCI state corresponding to the resource pool of the TCI state or the mode of the TCI state. In this embodiment of this application, it is convenient to determine a target TCI state used for transmission on the target resource, and the target resource can further be transmitted based on the determined target TCI state, thereby improving communication validity.

Optionally, in an embodiment, the receiving module 402 may be configured to receive a second MAC CE or first downlink control information DCI, where the second MAC CE or the first DCI is used to indicate a target TCI state used for transmission on the target resource, and the target TCI state is at least one of TCI states activated by the first MAC CE.

Optionally, in an embodiment, the resource pool of the TCI state meets at least one of the following: the resource pool of the TCI state is associated with a control resource set resource pool index CORESETPoolIndex; the resource pool of the TCI state is associated with the target TCI state; the resource pool of the TCI state is associated with a format of second DCI, and the second DCI is used to schedule the target resource; the resource pool of the TCI state is associated with the mode of the TCI state; and the resource pool of the TCI state is associated with the target resource.

Optionally, in an embodiment, the mode of the TCI state meets at least one of the following: the mode of the TCI state is associated with a CORESETPoolIndex; the mode of the TCI state is associated with the target TCI state; the mode of the TCI state is associated with a format of second DCI, and the second DCI is used to schedule the target resource; the mode of the TCI state is associated with the resource pool of the TCI state; and the mode of the TCI state is associated with the target resource.

Optionally, in an embodiment, the first MAC CE includes at least one of the following: a CORESETPoolIndex, a sounding reference signal SRS resource set identifier, a panel identifier, a resource pool identifier of the TCI state, the mode of the TCI state, and information about at least one code point.

Optionally, in an embodiment, the first MAC CE includes code point information, the code point information is used to indicate a to-be-activated TCI state, and the code point information includes at least one of the following: an identifier of the activated TCI state selected from the resource pool of the TCI state; an identifier used to distinguish between uplink and downlink; an identifier used to distinguish a TCI state group to which the activated TCI state belongs; and a mode of the activated TCI state, where the mode of the activated TCI state includes joint indication or separate indication.

Optionally, in an embodiment, the first DCI includes one TCI field, and the one TCI field corresponds to target code point information in one first MAC CE; the first DCI includes one TCI field, and the one TCI field corresponds to target code point information in a plurality of first MAC CEs; the first DCI includes a plurality of TCI fields, and the plurality of TCI fields correspond to different target code point information in one first MAC CE; or the first DCI includes a plurality of TCI fields, and each of the plurality of TCI fields corresponds to target code point information in one first MAC CE.

Optionally, in an embodiment, the second MAC CE or the first DCI includes a first indication field, and the first indication field is used by the terminal to determine at least one of the following based on a plurality of currently effective TCI states: a quantity of TCI states associated with the target resource, an identifier of a TCI state associated with the target resource, and a sequence of a plurality of TCI states associated with the target resource; and the plurality of currently effective TCI states are indicated by the second MAC CE or the first DCI.

Optionally, in an embodiment, the receiving module 402 may be configured to receive second DCI, where the second DCI is used to schedule the target resource, the second DCI includes a first indication field, and the first indication field is used by the terminal to determine at least one of the following based on a plurality of currently effective TCI states: a quantity of TCI states associated with the target resource, an identifier of a TCI state associated with the target resource, and a sequence of a plurality of TCI states associated with the target resource; and the plurality of currently effective TCI states are indicated by the second MAC CE or the first DCI.

Optionally, in an embodiment, a processing module is further included and is configured to: use a preset TCI state in TCI states activated by the first MACCE as the target TCI state; or a TCI state associated with a preset code point in the first MAC CE as the target TCI state.

Optionally, in an embodiment, the target resource is scheduled by second DCI, and the apparatus further includes a processing module, configured to determine, based on a format of the second DCI, a target TCI state used for transmission on a target resource, where the format of the second DCI includes one of the following: DCI format 1_0 and DCI format 0_0.

Optionally, in an embodiment, the second MAC CE or the first DCI is associated with a CORESETPoolIndex, and the apparatus further includes a processing module, configured to determine, based on at least one of the following, the target TCI state used by the target resource: the second MAC CE or the first DCI, or the CORESETPoolIndex.

Optionally, in an embodiment, that the second MAC CE or the first DCI is associated with the CORESETPoolIndex includes: the second MAC CE includes an indication field indicating the CORESETPoolIndex, or a first CORESET in which the first DCI is located is associated with the CORESETPoolIndex.

Optionally, in an embodiment, the target resource is associated with a CORESETPoolIndex, and the apparatus further includes a processing module, configured to determine, based on at least one of the following, the target TCI state used by the target resource: the second MAC CE or the first DCI, or the CORESETPoolIndex.

Optionally, in an embodiment, the target TCI state used by the target resource associated with the CORESETPoolIndex is indicated by the second MAC CE or the first DCI associated with the CORESETPoolIndex.

Optionally, in an embodiment, the target TCI state used by the target resource associated with the CORESETPoolIndex is indicated by the second MAC CE, where the second MAC CE meets at least one of the following: the second MAC CE is associated with the CORESETPoolIndex; the target TCI state used by the target resource is determined based on an arrangement sequence of a plurality of TCI states in the second MAC CE; and the target TCI state used by the target resource is a TCI state corresponding to a preset code point in the second MAC CE.

Optionally, in an embodiment, that the target resource is associated with the CORESETPoolIndex meets one of the following: a second CORESET in which second DCI is located is associated with the CORESETPoolIndex, where the second DCI is used to schedule the target resource; the CORESETPoolIndex associated with configuration of the target resource is configured by using higher layer signaling; and there is a mapping relationship between an identifier of the target resource and an identifier of the CORESETPoolIndex.

Optionally, in an embodiment, the second MAC CE or the first DCI includes a second indication field, and the second indication field is used to indicate that a target TCI state in the second MAC CE or the first DCI is applied to the target resource associated with target CORESETPoolIndex.

Optionally, in an embodiment, the second MAC CE or the first DCI indicates a plurality of TCI states, and the apparatus further includes a processing module, configured to perform at least one of the following:
(1) in a case that the target resource is a physical downlink control channel PDCCH, determining, from the plurality of TCI states based on an identifier of search space associated with the PDCCH, a target TCI state used for transmission on the PDCCH; and
(2) in a case that the target resource is a PDCCH, determining, from the plurality of TCI states based on an identifier of a control resource set associated with search space associated with the PDCCH, a TCI state used for transmission on the PDCCH.

Optionally, in an embodiment, the plurality of TCI states include a first TCI state and a second TCI state, and the search space includes first search space and second search space. The determining, from the plurality of TCI states, a TCI state used for transmission on the PDCCH includes: using, by a PDCCH transmitted by using the first search space, the first TCI state, and using, by a PDCCH transmitted by using the second search space, the second TCI state.

Optionally, in an embodiment, the plurality of TCI states include a first TCI state and a second TCI state, and the control resource set includes a first control resource set and a second control resource set. The determining, from the plurality of TCI states, a TCI state used for transmission on the PDCCH includes: using, by a PDCCH transmitted by using the first control resource set, the first TCI state, and using, by a PDCCH transmitted by using the second control resource set, the second TCI state.

Optionally, in an embodiment, the second MAC CE or the first DCI indicates a plurality of TCI states, and the apparatus further includes a processing module, configured to perform at least one of the following:
(1) in a case that the target resource is a PUSCH and a sounding reference signal SRS resource set used for transmission on the PUSCH is associated with a channel state information reference signal CSI-RS, determining, from the plurality of TCI states based on an identifier of the SRS resource set, a TCI state used for transmission on the CSI-RS; and
(2) in a case that the target resource is a PUSCH, determining, from the plurality of TCI states based on an identifier of an SRS resource set, a TCI state used for transmission on the SRS resource set, where the SRS resource set is used for transmission on the PUSCH.

Optionally, in an embodiment, the plurality of TCI states include a first TCI state and a second TCI state, and the SRS resource set includes a first SRS resource set and a second SRS resource set. The determining, from the plurality of TCI states based on an identifier of an SRS resource set, a TCI state used for transmission on the CSI-RS includes: using, by a CSI-RS associated with the first SRS resource set, the first TCI state, and using, by a CSI-RS associated with the second SRS resource set, the second TCI state.

Optionally, in an embodiment, the plurality of TCI states include a first TCI state and a second TCI state, and the SRS resource set includes a first SRS resource set and a second SRS resource set. The determining, from the plurality of TCI states based on an identifier of the SRS resource set, a TCI state used for transmission on the SRS resource set includes: using, by the first SRS resource set, the first TCI state, and using, by the second SRS resource set, the second TCI state.

Optionally, in an embodiment, the target resource at least one of the following: a PDCCH, a control resource set, search space, a physical downlink shared channel PDSCH, a physical uplink control channel PUCCH, a PUSCH, a CSI-RS, an SRS resource, and an SRS resource set.

For the apparatus 400 according to this embodiment of this application, reference may be made to the procedures of the method 200 in the embodiments of this application, and the units/modules in the apparatus 400 and the foregoing operations and/or functions are respectively for implementing the corresponding procedures of the method 200 and can achieve a same or equivalent technical effect. For brevity, details are not described herein again.

The information processing apparatus in this embodiment of this application may be an apparatus or an electronic device with an operating system, or may be a component, an integrated circuit, or a chip in a terminal. The apparatus or electronic device may be a mobile terminal, or a non-mobile terminal. For example, mobile terminals can include, but are not limited to, the types of terminals 11 listed above. Non-mobile terminals can be servers, network attached storage (Network Attached Storage, NAS), personal computers (personal computer, PC), televisions (television, TV), teller machines or self-service machines. The embodiments of the application are not specifically defined.

The TCI state indication apparatus provided in this embodiment of this application can implement the processes implemented in the method embodiment in FIG. 2, and a same technical effect is achieved. To avoid repetition, details are not described herein again.

FIG. 5 is a schematic diagram of a structure of a TCI state indication apparatus according to an embodiment of this application. The apparatus may correspond to a network side device in another embodiment. As shown in FIG. 5, an apparatus 500 includes the following module:

A sending module 502 may be configured to: send RRC signaling, where the RRC signaling is used to indicate at least one of a resource pool of a TCI state and a mode of the TCI state; and send a first MAC CE, where the first MAC CE is configured to activate at least one TCI state corresponding to the resource pool of the TCI state or the mode of the TCI state.

In this embodiment of this application, the apparatus 500 sends the RRC signaling, where the RRC signaling is used to indicate at least one of the resource pool of the TCI state and the mode of the TCI state; and then, the apparatus 500 sends the first MAC CE, where the first MAC CE is used to activate at least one TCI state corresponding to the resource pool of the TCI state or the mode of the TCI state. In this embodiment of this application, it is convenient for a terminal to determine a target TCI state used for transmission on a target resource, and the terminal can further transmit the target resource based on the determined target TCI state, thereby improving communication validity.

Optionally, in an embodiment, the sending module 502 may be configured to send a second MAC CE or first DCI, where the second MAC CE or the first DCI is used to indicate a target TCI state used for transmission on a target resource, and the target TCI state is at least one of TCI states activated by the first MAC CE.

Optionally, in an embodiment, the resource pool of the TCI state meets at least one of the following: the resource pool of the TCI state is associated with a CORESETPoolIndex; the resource pool of the TCI state is associated with the target TCI state; the resource pool of the TCI state is associated with a format of second DCI, and the second DCI is used to schedule the target resource; the resource pool of the TCI state is associated with the mode of the TCI state; and the resource pool of the TCI state is associated with the target resource.

Optionally, in an embodiment, the mode of the TCI state meets at least one of the following: the mode of the TCI state is associated with a CORESETPoolIndex; the mode of the TCI state is associated with the target TCI state; the mode of the TCI state is associated with a format of second DCI, and the second DCI is used to schedule the target resource; and the mode of the TCI state is associated with the resource pool of the TCI state.

Optionally, in an embodiment, the first MAC CE includes code point information, the code point information is used to indicate a to-be-activated TCI state, and the code point information includes at least one of the following: an identifier of the activated TCI state selected from the resource pool of the TCI state; an identifier used to distinguish between uplink and downlink; an identifier used to distinguish a TCI state group to which the activated TCI state belongs; and a mode of the activated TCI state, where the mode of the activated TCI state includes joint indication or separate indication.

Optionally, in an embodiment, the first DCI includes one TCI field, and the one TCI field corresponds to target code point information in one first MAC CE; the first DCI includes one TCI field, and the one TCI field corresponds to target code point information in a plurality of first MAC CEs; the first DCI includes a plurality of TCI fields, and the plurality of TCI fields correspond to different target code point information in one first MAC CE; or the first DCI includes a plurality of TCI fields, and each of the plurality of TCI fields corresponds to target code point information in one first MAC CE.

Optionally, in an embodiment, the first DCI includes a first indication field, the first indication field is used to indicate an association relationship between a plurality of currently effective TCI states and the target resource, and the association relationship includes at least one of the following: a quantity of TCI states associated with the target resource; an identifier of a TCI state associated with the target resource; and a sequence of a plurality of TCI states associated with the target resource.

Optionally, in an embodiment, the sending module 502 may be further configured to send second DCI, where the second DCI is used to schedule the target resource. The target TCI state used for transmission on the target resource is determined by the terminal based on a format of the second DCI, and the format of the second DCI includes one of the following: DCI format 1_0 and DCI format 0_0.

Optionally, in an embodiment, the second MAC CE or the first DCI is associated with a CORESETPoolIndex.

Optionally, in an embodiment, the target resource is associated with a CORESETPoolIndex.

The apparatus 500 according to this embodiment of this application may correspond to the procedures of the method 300 in the embodiments of this application, and the units/modules in the apparatus 500 and the foregoing operations and/or functions are separately for implementing the corresponding procedures of the method 300, and can achieve a same or equivalent technical effect. For brevity, details are not described herein again.

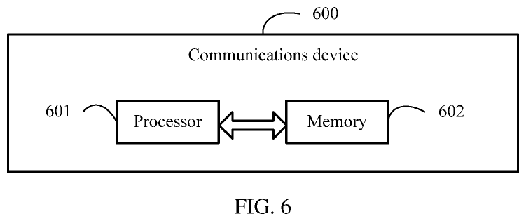

Optionally, as shown in FIG. 6, an embodiment of this application further provides a communications device 600, including a processor 601, a memory 602, and a program or an instruction that is stored in the memory 602 and that can be run on the processor 601. For example, when the communications device 600 is a terminal, the program or the instruction is executed by the processor 601 to implement the processes of the foregoing embodiment of the TCI state indication method, and a same technical effect can be achieved. When the communications device 600 is a network side device, the program or the instruction is executed by the processor 601 to implement the processes of the foregoing embodiment of the TCI state indication method, and a same technical effect can be achieved. To avoid repetition, details are not described herein again.

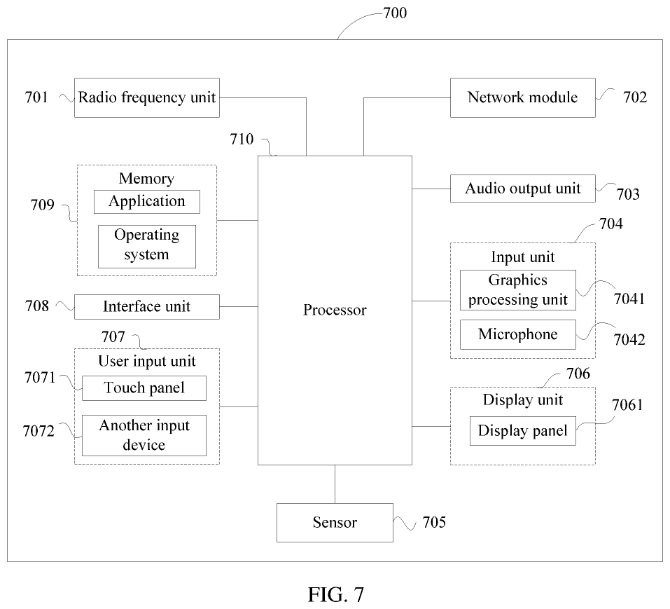

An embodiment of this application further provides a terminal, including a processor and a communications interface. The processor is configured to determine a target TCI state used by a target resource, and the communications interface is configured to: receive RRC signaling, where the RRC signaling is used to indicate at least one of a resource pool of a TCI state and a mode of the TCI state; and receive a first MAC CE, where the first MAC CE is configured to activate at least one TCI state corresponding to the resource pool of the TCI state or the mode of the TCI state. This terminal embodiment corresponds to the foregoing method embodiment on the terminal side. Each implementation process and implementation of the foregoing method embodiment may be applicable to this terminal embodiment, and a same technical effect can be achieved. Specifically, FIG. 7 is a schematic diagram of a hardware structure of a terminal according to an embodiment of this application.

A terminal 700 includes but is not limited to at least some components in a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 by using a power supply management system, to implement functions such as charging and discharging management and power consumption management by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that, in this embodiment of this application, the input unit 704 may include a graphics processing unit (Graphics Processing Unit, GPU) 7041 and a microphone 7042, and the graphics processing unit 7041 processes image data of a still picture or a video obtained by an image capture apparatus (such as a camera) in a video capture mode or an image capture mode. The display unit 706 may include a display panel 7061. Optionally, the display panel 7061 may be configured in a form such as a liquid crystal display or an organic light-emitting diode. The user input unit 707 includes a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, the radio frequency unit 701 receives downlink data from a network side device and then sends the downlink data to the processor 710 for processing; and sends uplink data to the network side device. Usually, the radio frequency unit 701 includes but is not limited to an antenna, at least one amplifier, a transceiver, a coupler, a low noise amplifier, a duplexer, and the like.

The memory 709 may be configured to store a software program or an instruction and various data. The memory 709 may mainly include a program or instruction storage area and a data storage area. The program or instruction storage area may store an operating system, and an application or an instruction required by at least one function (for example, a sound playing function or an image playing function). In addition, the memory 709 may include a high-speed random access memory, or may further include a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory, for example, at least one disk storage component, a flash memory component, or another non-transient solid-state storage component.

The processor 710 may include one or more processing units. Optionally, an application processor and a modem processor may be integrated into the processor 710. The application processor mainly processes an operating system, a user interface, an application, an instruction, or the like. The modem processor mainly processes wireless communication, for example, a baseband processor. It can be understood that, alternatively, the modem processor may not be integrated into the processor 710.

The radio frequency unit 701 may be configured to: receive RRC signaling, where the RRC signaling is used to indicate at least one of a resource pool of a TCI state and a mode of the TCI state; and receive a first MAC CE, where the first MAC CE is configured to activate at least one TCI state corresponding to the resource pool of the TCI state or the mode of the TCI state.

The processor 710 may be configured to determine a target TCI state used for transmission on a target resource.

In this embodiment of this application, the terminal receives the RRC signaling, where the RRC signaling is used to indicate at least one of the resource pool of the TCI state and the mode of the TCI state, and then the terminal receives the first MAC CE, where the first MAC CE is used to activate at least one TCI state corresponding to the resource pool of the TCI state or the mode of the TCI state. In this embodiment of this application, it is convenient for a terminal to determine a target TCI state used for transmission on a target resource, and the terminal can further transmit the target resource based on the determined target TCI state, thereby improving communication validity.

The terminal 700 provided in this embodiment of this application can implement the processes of the forgoing embodiment of the TCI state indication method, and achieve a same technical effect. To avoid repetition, details are not described herein again.

An embodiment of this application further provides a network side device, including a processor and a communications interface. The communications interface is configured to: send RRC signaling, where the RRC signaling is used to indicate at least one of a resource pool of a TCI state and a mode of the TCI state; and send a first MAC CE, where the first MAC CE is configured to activate at least one TCI state corresponding to the resource pool of the TCI state or the mode of the TCI state. This network side device embodiment corresponds to the foregoing method embodiment on the network side device. Each implementation process and implementation of the foregoing method embodiment may be applicable to this network side device embodiment, and a same technical effect can be achieved.

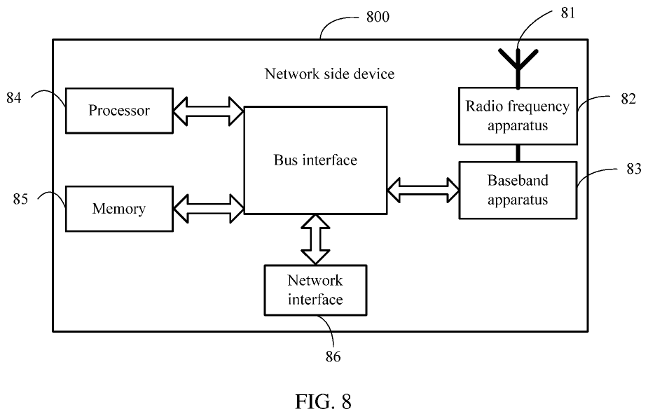

Specifically, an embodiment of this application further provides a network side device. As shown in FIG. 8, a network side device 800 includes an antenna 81, a radio frequency apparatus 82, and a baseband apparatus 83. The antenna 81 is connected to the radio frequency apparatus 82. In an uplink direction, the radio frequency apparatus 82 receives information by using the antenna 81, and sends the received information to the baseband apparatus 83 for processing. In a downlink direction, the baseband apparatus 83 processes to-be-sent information, and sends the information to the radio frequency apparatus 82. The radio frequency apparatus 82 processes the received information and then sends the information by using the antenna 81.

The frequency band processing apparatus may be located in the baseband apparatus 83. The method performed by the network side device in the foregoing embodiment may be implemented in the baseband apparatus 83. The baseband apparatus 83 includes a processor 84 and a memory 85.

The baseband apparatus 83 may include, for example, at least one baseband board, where a plurality of chips are disposed on the baseband board. As shown in FIG. 8, one chip is, for example, the processor 84, which is connected to the memory 85, so as to invoke a program in the memory 85 to perform operations of the network side device shown in the foregoing method embodiment.

The baseband apparatus 83 may further include a network interface 86, configured to exchange information with the radio frequency apparatus 82. For example, the interface is a common public radio interface (common public radio interface, CPRI).

Specifically, the network side device in this embodiment of this application further includes an instruction or a program that is stored in the memory 85 and that can be run on the processor 84. The processor 84 invokes the instruction or the program in the memory 85 to perform the method performed by the modules shown in FIG. 5, and a same technical effect is achieved. To avoid repetition, details are not described herein again.

An embodiment of this application further provides a readable storage medium. The readable storage medium stores a program or an instruction, and when the program or the instruction is executed by a processor, the processes of the foregoing embodiment of the TCI state indication are implemented and a same technical effect can be achieved. To avoid repetition, details are not described herein again.

The processor is the processor in the terminal described in the foregoing embodiment. The readable storage medium includes a computer-readable storage medium, such as a computer read-only memory (Read-Only Memory, ROM), a random access memory (Random Access Memory, RAM), a magnetic disk, or an optical disc.

An embodiment of this application further provides a chip. The chip includes a processor and a communications interface, the communications interface is coupled to the processor, and the processor is configured to run a program or an instruction to implement the processes of the foregoing method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a software product. The computer software product is stored in a storage medium (such as a ROM/RAM, a hard disk, or an optical disc), and includes several instructions for instructing a terminal (which may be mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application.

1. A transmission configuration indication (TCI) state indication method, comprising:
receiving, by a terminal, Radio Resource Control (RRC) signaling, wherein the RRC signaling is used to indicate at least one of a resource pool of a TCI state and a mode of the TCI state; and
receiving, by the terminal, a first Media Access Control control element (MAC CE), wherein the first MAC CE is configured to activate at least one TCI state corresponding to the resource pool of the TCI state or the mode of the TCI state.

2. The method according to claim 1, wherein after the receiving, by the terminal, a first Media Access Control control element MAC CE, the method further comprises:
receiving, by the terminal, a second MAC CE or first downlink control information (DCI), wherein the second MAC CE or the first DCI is used to indicate a target TCI state used for transmission on a target resource, and the target TCI state is at least one of TCI states activated by the first MAC CE.

3. The method according to claim 2, wherein the resource pool of the TCI state meets at least one of the following:
the resource pool of the TCI state is associated with a control resource set resource pool index CORESETPoolIndex;
the resource pool of the TCI state is associated with the target TCI state;
the resource pool of the TCI state is associated with a format of second DCI, and the second DCI is used to schedule the target resource;
the resource pool of the TCI state is associated with the mode of the TCI state; and
the resource pool of the TCI state is associated with the target resource.

4. The method according to claim 2, wherein the mode of the TCI state meets at least one of the following:
the mode of the TCI state is associated with a CORESETPoolIndex;
the mode of the TCI state is associated with the target TCI state;
the mode of the TCI state is associated with a format of second DCI, and the second DCI is used to schedule the target resource;
the mode of the TCI state is associated with the resource pool of the TCI state; and
the mode of the TCI state is associated with the target resource.

5. The method according to claim 2, wherein the first MAC CE comprises code point information, the code point information is used to indicate a to-be-activated TCI state, and the code point information comprises at least one of the following:
an identifier of the activated TCI state selected from the resource pool of the TCI state;
an identifier used to distinguish between uplink and downlink;
an identifier used to distinguish a TCI state group to which the activated TCI state belongs; and
a mode of the activated TCI state, wherein the mode of the activated TCI state comprises joint indication or separate indication.

6. The method according to claim 2, wherein the second MAC CE or the first DCI comprises a first indication field, and the first indication field is used by the terminal to determine at least one of the following based on a plurality of currently effective TCI states: a quantity of TCI states associated with the target resource, an identifier of a TCI state associated with the target resource, and a sequence of a plurality of TCI states associated with the target resource; and
the plurality of currently effective TCI states are indicated by the second MAC CE or the first DCI.

7. The method according to claim 2, wherein the method further comprises:
receiving, by the terminal, second DCI, wherein the second DCI is used to schedule the target resource, the second DCI comprises a first indication field, and the first indication field is used by the terminal to determine at least one of the following based on a plurality of currently effective TCI states: a quantity of TCI states associated with the target resource, an identifier of a TCI state associated with the target resource, and a sequence of a plurality of TCI states associated with the target resource; and
the plurality of currently effective TCI states are indicated by the second MAC CE or the first DCI.

8. The method according to claim 1, wherein the method further comprises:
using, by the terminal, a preset TCI state in TCI states activated by the first MAC CE as the target TCI state; or
using, by the terminal, a TCI state associated with a preset code point in the first MAC CE as the target TCI state.

9. The method according to claim 1, wherein the target resource is scheduled by using second DCI, and the method further comprises:
determining, by the terminal based on a format of the second DCI, a target TCI state used for transmission on a target resource, wherein the format of the second DCI comprises one of the following:
DCI format 1_0 and DCI format 0_0.

10. The method according to claim 2, wherein the second MAC CE or the first DCI is associated with a CORESETPoolIndex, and the method further comprises:
determining, based on at least one of the following, the target TCI state used by the target resource: the second MAC CE or the first DCI, or the CORESETPoolIndex.

11. The method according to claim 2, wherein the target resource is associated with a CORESETPoolIndex, and the method further comprises:
determining, based on at least one of the following, the target TCI state used by the target resource: the second MAC CE or the first DCI, or the CORESETPoolIndex.

12. A TCI state indication method, comprising:
sending, by a network side device, RRC signaling, wherein the RRC signaling is used to indicate at least one of a resource pool of a TCI state and a mode of the TCI state; and
sending, by the network side device, a first MAC CE, wherein the first MAC CE is used to activate at least one TCI state corresponding to the resource pool of the TCI state or the mode of the TCI state.

13. The method according to claim 12, wherein after the sending, by the network side device, a first MAC CE, the method further comprises:
sending, by the network side device, a second MAC CE or first DCI, wherein the second MAC CE or the first DCI is used to indicate a target TCI state used for transmission on a target resource, and the target TCI state is at least one of TCI states activated by the first MAC CE.

14. The method according to claim 13, wherein the resource pool of the TCI state meets at least one of the following:
the resource pool of the TCI state is associated with a CORESETPoolIndex;
the resource pool of the TCI state is associated with the target TCI state;
the resource pool of the TCI state is associated with a format of second DCI, and the second DCI is used to schedule the target resource;
the resource pool of the TCI state is associated with the mode of the TCI state; and
the resource pool of the TCI state is associated with the target resource.

15. The method according to claim 13, wherein the mode of the TCI state meets at least one of the following:
the mode of the TCI state is associated with a CORESETPoolIndex;
the mode of the TCI state is associated with the target TCI state;
the mode of the TCI state is associated with a format of second DCI, and the second DCI is used to schedule the target resource;
the mode of the TCI state is associated with the resource pool of the TCI state; and
the mode of the TCI state is associated with the target resource.

16. The method according to claim 13, wherein the first MAC CE comprises code point information, the code point information is used to indicate a to-be-activated TCI state, and the code point information comprises at least one of the following:
an identifier of the activated TCI state selected from the resource pool of the TCI state;
an identifier used to distinguish between uplink and downlink;
an identifier used to distinguish a TCI state group to which the activated TCI state belongs; and
a mode of the activated TCI state, wherein the mode of the activated TCI state comprises joint indication or separate indication.

17. The method according to claim 13, wherein the first DCI comprises a first indication field, the first indication field is used to indicate an association relationship between a plurality of currently effective TCI states and the target resource, and the association relationship comprises at least one of the following:
a quantity of TCI states associated with the target resource;
an identifier of a TCI state associated with the target resource; and
a sequence of a plurality of TCI states associated with the target resource.

18. The method according to claim 12, wherein the method further comprises: sending, by the network side device, second DCI, wherein the second DCI is used to schedule the target resource; and
the target TCI state used for transmission on the target resource is determined by a terminal based on a format of the second DCI, and the format of the second DCI comprises one of the following: DCI format 1_0 and DCI format 0_0.

19. A terminal, comprising a processor, a memory, and a program or an instruction that is stored in the memory and that can run on the processor, wherein when the program or the instruction is executed by the processor, the following steps are implemented:
receiving RRC signaling, wherein the RRC signaling is used to indicate at least one of a resource pool of a TCI state and a mode of the TCI state; and
receiving a first MAC CE, wherein the first MAC CE is configured to activate at least one TCI state corresponding to the resource pool of the TCI state or the mode of the TCI state.

20. A network side device, comprising a processor, a memory, and a program or an instruction that is stored in the memory and that can run on the processor, wherein when the program or the instruction is executed by the processor, the TCI state indication method according to claim 12 is implemented.
